(19) United States
(12) Patent Application Publication
(10) Pub. No.: US 2026/0310243 A1
(43) Pub. Date: Oct. 8, 2026

(54) SYSTEMS AND METHOD FOR DYNAMICALLY CALIBRATING A FLUID DISPENSING SYSTEM

(71) Applicant: Zaxis, Inc., West Valley City, UT (US)

(72) Inventors: John Zachary Peeler, West Valley City, UT (US); William B. Dunkley, West Valley City, UT (US); Steven B. Guest, West Valley City, UT (US); Christopher H. Jensen, West Valley City, UT (US)

(21) Appl. No.: 19/637,285

(22) Filed: Apr. 2, 2026

Related U.S. Application Data
(60) Provisional application No. 63/782,190, filed on Apr. 2, 2025.

(51) Int. Cl. G05D 7/06; F04B 49/12; F04B 51/00

(52) U.S. Cl. CPC G05D 7/0676; F04B 49/12; F04B 51/00

(57) ABSTRACT

A fluid dispensing system may include a pump, a motor coupled to the pump to selectively drive a movable element, one or more sensors in communication with at least one of (i) the motor and (ii) the pump, and configured to determine position data of the movable element and an output flow rate of the pump, and a controller in communication with the motor and configured to dynamically adjust the motor relative to an amount of fluid dispensed from the system.

### CROSS-REFERENCE TO RELATED APPLICATION

This application claims priority to United States Provisional Patent Application Serial No. 63/782,190 (Attorney Docket No. 10847.33), filed Apr. 2, 2025, and entitled “SYSTEMS AND METHOD FOR DYNAMICALLY CALIBRATING A FLUID DISPENSING SYSTEM”; the entire disclosure of which are hereby incorporated by reference.

### BACKGROUND OF THE INVENTION

### 1. Field of the Invention

The present invention relates to fluid dispensing systems, and more particularly to reciprocating fluid dispensing systems and systems and methods of dynamically calibrating the same.

### 2. Background and Related Art

Fluid dispensing pump systems are widely used in various industries, including pharmaceuticals, food and beverage, chemical manufacturing, and medical applications, to deliver precise quantities of liquids, chemicals, and other substances. It is desired for such pump systems to provide repeatable results over time without clogging, requiring manual adjustments, or regular cleaning or maintenance.

While techniques currently exist that are used in industries requiring a safe, accurate handling of fluid, challenges still exist with such techniques. Accordingly, it would be an improvement in the art to augment or even replace current techniques with other techniques.

### BRIEF SUMMARY OF THE INVENTION

The present disclosure relates generally to a fluid dispensing system that includes a pump, a motor coupled to the pump to selectively drive a movable element, one or more sensors in communication with at least one of (i) the motor and (ii) the pump, and configured to determine position data of the movable element and an output flow rate of the pump, and a controller in communication with the motor and configured to dynamically adjust the motor relative to an amount of fluid dispensed from the system.

Some aspects of the present disclosure relate to method of dynamically calibrating a fluid dispensing system, the method including receiving position data from a position sensor associated with a motor configured to drive a reciprocating pump dispenser, receiving flow rate data from a sensor associated with the reciprocating fluid pump dispenser, comparing the received flow rate data with a predefined flow rate data to determine any discrepancies, determining corrections to be applied to the motor to compensate for the determined differences, and transmitting control signals including the corrections to the motor.

Additional aspects of the present disclosure relate to a displacement fluid dispensing system, the system including a displacement mechanism having a movable element within a chamber, an actuator element coupled to the displacement mechanism to selectively actuate movement of the movable element, a first position sensor in communication with the motor to monitor a position of the motor, an adjustment component configured to modify a position of the movable element, a second position sensor in communication with the adjustment mechanism to monitor a position of the adjustment mechanism, one or more sensors configured to measure an output flow rate of the positive displacement pump, and a controller. The controller may be programmed to collect position information from the first position sensor and the second positions sensor, gather flow rate data from the first position sensor and the second positions sensor, identify mismatches based on the position information and the flow rate data, and send control signals to the motor and/or the adjustment mechanism to compensate for these mismatches.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative system that provides a suitable operating environment for use in association with at least some embodiments of the present disclosure;

FIG. 2 is a perspective view of a reciprocating pump with an integrally formed sensor, in accordance with one or more embodiments of the present disclosure;

FIG. 3 is a perspective view of a reciprocating pump with an integrally formed sensor, in accordance with one or more embodiments of the present disclosure;

FIG. 4 is a perspective view of a reciprocating pump with an integrally formed sensor, in accordance with one or more embodiments of the present disclosure;

FIG. 5 is a perspective view of a reciprocating pump, in accordance with one or more embodiments of the present disclosure;

FIG. 6 is a perspective view of a reciprocating pump, in accordance with one or more embodiments of the present disclosure; and

FIG. 7 is a perspective view of a reciprocating pump with a distal end sensor, in accordance with one or more embodiments of the present disclosure.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present disclosure take place in association with a reciprocating fluid pump. In at least one embodiment, a pump drive motor is coupled to the reciprocating fluid pump to actuate a pump shaft within a pump cylinder, wherein the pump shaft includes a duct that allows fluid to selectively pass thereby within the pump cylinder. As the pump shaft rotates within the pump cylinder, fluid is allowed to enter into a pump bore defined by a portion of the pump cylinder through a pump ingress port. As the pump shaft rotates further, the shaft blocks the pump ingress port. Further rotation allows the duct of the shaft to allow the fluid in the pump bore to be dispensed through a pump egress port. This process may be repeated for subsequently dispensing volumes of fluid using the synchronously and/or asynchronously reciprocating fluid pump.

One or more embodiments of the present disclosure includes an adjustment motor (e.g., a linear actuator, etc.) that is coupled to an adjustment mechanism, which selectively adjusts the volume of the pump bore. In at least one embodiment, the volume of the pump bore is adjusted as the angle of the pump shaft is modified. A modification of the angle changes the stroke of the pump shaft.

Some embodiments of the present disclosure include a computer device (e.g., a controller or other computer device) that is coupled to the main pump drive motor and the adjustment linear actuator to dynamically control the adjustment linear actuator and cause the adjustment mechanism to be precisely and repeatably modified. As such, the volume of fluid dispensed is extremely accurate, repeatable, and dynamic, as will be further discussed below.

One or more embodiments include one or more sensors and encoders that measure, among other things, an input and an output dispensed by the pump and a position of the main pump drive motor and the adjustment linear actuator. The measured output may be compared to a desired output, allowing the controller to automatically transmit control signals to calibrate the pump such that the output is more precise and accurate as compared to the desired output.

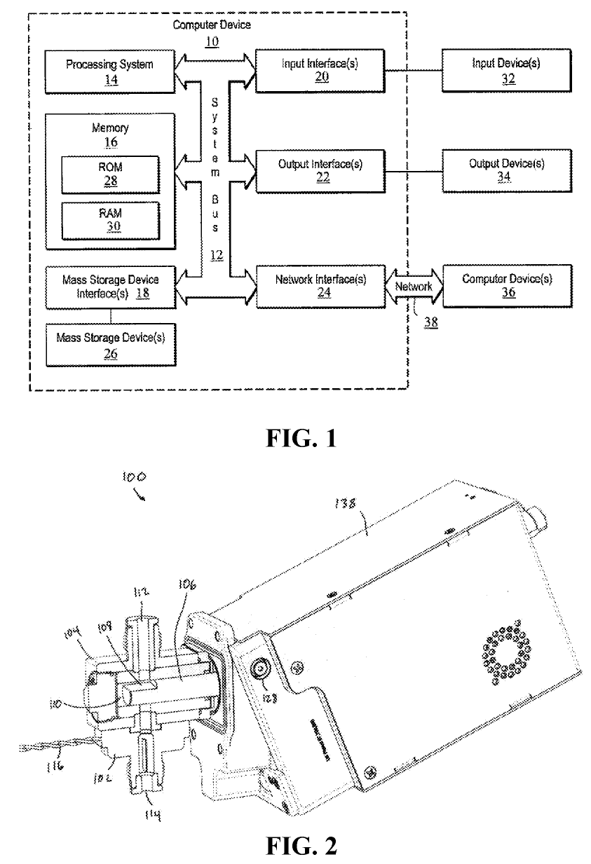

FIG. 1 and the corresponding discussion are intended to provide a general description of a suitable operating environment in which the invention may be implemented. One skilled in the art will appreciate that the disclosure may be practiced by one or more computing devices and in a variety of system configurations, including in a networked configuration.

Embodiments of the present disclosure embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, at least some embodiments of the present disclosure for dynamically calibrating a fluid dispensing system include a controller, a computer device, or a computer system for implementing at least some aspect of the invention. Accordingly, FIG. 1 depicts a representative computer device, illustrated as computer device 10, which may be a general-purpose or special-purpose computer. For example, computer device 10 may be a controller, a personal computer, a notebook computer, a personal digital assistant (“PDA”), smartphone, or other hand-held device, a workstation, a minicomputer, a mainframe, a supercomputer, a multi-processor system, a network computer, a processor-based consumer electronic device, or another computer device.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a sensor, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

FIG. 2 is a perspective view of a reciprocating pump 100 with an integrally formed sensor 102, in accordance with one or more embodiments of the present disclosure. In some embodiments, pump 100 includes a pump drive motor housed in pump motor housing 138, a cylinder bore 104, ports 112 and 114, and a sensor 102 coupled to cylinder bore 104. In some embodiments, port 112 is an ingress port coupled to a liquid source and port 114 is an egress port coupled to a liquid dispensing target, where pump 100 is configured to move liquid from the liquid source to the liquid dispensing target. In one or more embodiments, movement of liquid may be switched, where port 112 is an egress port while port 114 is an ingress port, depending on a configuration of pump 100, namely depending on a direction of rotation of piston 106 and a pressure of a liquid at ports 112 or 114. Because the ports are essentially symmetrical and the direction of flow can be changed electronically, additional control is provided for pump 100. Additionally, pump 100, including ports 112 and 114 and cylinder bore 104 may be easier and can be automated.

FIG. 2 depicts pump 100 (i.e., a representative reciprocating fluid dispenser or positive displacement pump) having a chamber (e.g., a cylinder bore 104) in a cross-sectional view to illustrate a movable element (e.g., a piston 106), a duct 108, and a stroke size 110. In one or more embodiments, liquid is moved (i.e., pumped) from an ingress port 112 to an egress port 114 in any suitable manner. In some examples, during rotation of piston 106 (i.e., a pump shaft), duct 108 passes an ingress port 112, which allows liquid in ingress port 112 to selectively enter cylinder bore 104 (i.e., a pump cylinder). As piston 106 rotates, duct 108 rotates, sealing ingress port 112, and opening egress port 114 to allow for the liquid in cylinder bore 104 to selectively exit cylinder bore 104 via an egress port 114. In some embodiments, piston 106 moves linearly within cylinder bore 104 between a first or recessed position, and a second or extended position. The volume between piston 106 and the end of cylinder bore 104 determines stroke size 110. For example, a volume of stroke size 110 is greater when piston 106 is in the first or recessed position than when piston is in the second or extended position.

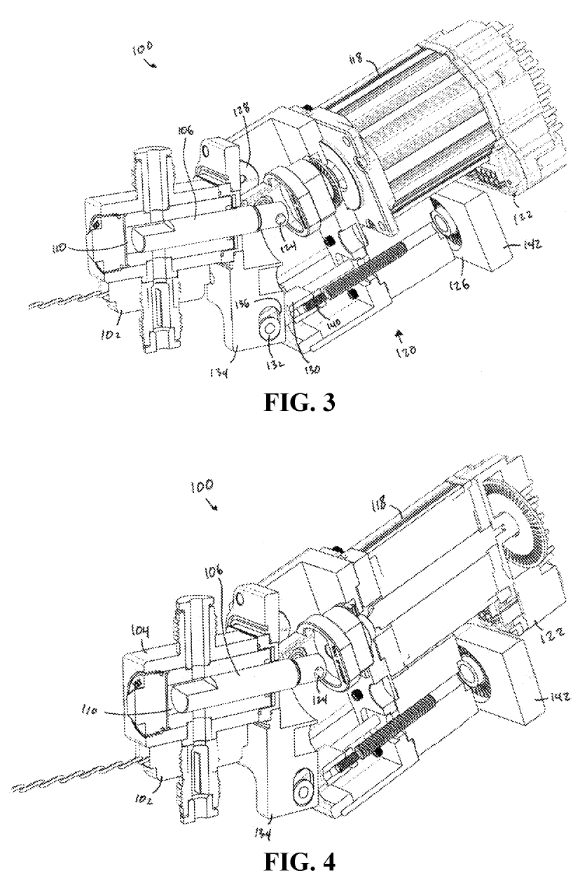

In some embodiments, the liquid flow out of egress port 114 may be measured and/or calculated via any suitable manner. For example, in some embodiments, sensor 102 is integrally formed with cylinder bore 104 (e.g., via molding, machining (e.g., via a computer numerical control (CNC) machine), casting, stamping, forging, etc.) as a monolithic unit. In other embodiments, sensor 102 is coupled or attached to cylinder bore 104 via bolts or other semi-permanent means. Sensor 102 may also be threadedly coupled to cylinder bore 104 (as shown in FIGS. 3 – 4). In some embodiments, sensor 102 includes features to retain tubing, pipes, or additional sensors. For example, in one or more embodiments, sensor 102 includes external threads configured to receive an internally threaded member, such as an additional sensor in series or a pipe or a tube that receives the liquid being passed through pump 100.

In some embodiments, sensor 102 is a flow meter that can measure the rate at which a liquid flows through egress port 114. Examples of sensor 102 include any suitable sensor that can measure and detect liquid flow, such as a thermal mass flowmeter, a laminar mass flowmeter, a mass flowmeter (e.g., a Coriolis flowmeter), a pressure-based meter (e.g., a venturi meter), an optical flowmeter, an ultrasonic flowmeter, a mechanical flowmeter, and a laser beam flowmeter. In one or more embodiments, a camera may be used to capture the output of pump 100 and a controller (e.g., computer device 10) may be configured to analyze images and video captured from the camera to collect flow rate data including precisely determine an output flow rate of pump 100 (e.g., using artificial intelligence or machine learning). By way of example, the camera may capture images of droplets and the controller may determine the flow rate by measuring the size of the droplets. Real-time data may be captured using sensor 102 regarding the volume, mass, and/or velocity of liquid that is flowing through egress port 114. Such real-time data is transmitted to the controller (not shown) for analysis, monitoring, calibration, adjustment, or other control purposes. Data collected at sensor 102 is transmitted to the controller via a wired power cable 116, or in some cases, data is transmitted to the controller wirelessly.

FIG. 3 is a perspective view of a reciprocating pump 100 with an integrally formed sensor 102, in accordance with one or more embodiments of the present disclosure. FIG. 3 illustrates certain internal details of pump 100, where housing 138 is not shown. For example, pump 100 is shown to include pump drive motor 118, adjustment mechanism 120 shown in cross-sectional view, pump drive position sensor (e.g., encoder) 122 linked to and in communication with pump drive motor 118, and pin 124, which is coupled to piston 106.

In one or more embodiments, pump 100 may be configured for automatic and instantaneous adjustment of shot size. For example, in some embodiments, an adjustment mechanism 120 is designed and configured to modify movement of piston 106. In one or more embodiments, adjustment mechanism 120 provides a mechanism for piston 106 to move linearly within cylinder bore 104, which increases or decreases stroke size 110, which in turn permits control over the shot size (i.e., volume or mass of liquid dispensed during a stroke). In some embodiments, adjustment mechanism 120 includes a linear actuator 126 (e.g., a micro-stepper servo motor), a hinge block pivot point 128, a pillow block 130, a cam follower 132, and a hinge block 134. Linear actuator 126 includes a lead screw 140 that is threaded into the center of pillow block 130 and may have a lock nut to prevent loosening. Linear actuator 126 controls the position of pillow block 130. A surface 136 of hinge block 134 is provided to allow a cam to run against surface 136, allowing the hinge block 134 to change angles based on linear motion of linear actuator 126. Linear actuator 126 can make ultra-fine adjustments to the angle of the pump, thereby changing the quantity of metered liquid. In some embodiments, adjustment mechanism 120 includes a position sensor (e.g., encoder) 142 which is linked to and in communication with linear actuator 126. In some embodiments, encoder 142 is configured to monitor linear actuator 126 and convert the motion of linear actuator 126 into an electrical signal that can be interpreted and analyzed by the controller. The controller can then use the information from encoder 142 to transmit control signals for additional fine-tuning of linear actuator 126 and pump 100.

FIG. 4 is a perspective view of a reciprocating pump 100 with an integrally formed sensor 102, in accordance with one or more embodiments of the present disclosure. FIG. 4 includes a cross-sectional view of pump drive motor 118 and pump drive encoder 122. Pump drive motor 118 causes piston 106 to rotate, and in some embodiments, to move linearly back and forth within cylinder bore 104. For example, in some embodiments, pump drive motor 118 is coupled to piston 106 via pin 124, causing piston 106 to rotate. Due to the angled position of hinge block 134, the linear position of pin 124 as pump drive motor 118 rotates will cause piston 106 to move linearly back and forth within cylinder bore 104.

Pump drive encoder 122 is coupled to pump drive motor 118 such that motion, position, and/or rotation of pump drive motor 118 is constantly monitored and transmitted in real time to the controller. In conjunction with sensor 102 (or any other sensors or encoders of pump 100), an absolute position of pump drive encoder 122 may be known, including in relation to an amount (e.g., a volume or mass) of liquid dispensed. For example, the controller is programmed to determine how many turns or partial turns of pump drive motor 118 correspond to an amount of liquid dispensed by comparing the measured turns of pump drive motor 118 to a measured amount of liquid dispensed (e.g., as measured by a sensor such as sensor 102). Additionally, upon receiving signals from pump drive encoder 122 and linear actuator encoder 142, the controller can determine the angle of hinge block 134, the relative position of pin 124, a rotational position of piston 106, stroke size 110, and the intended flow rate of liquid passing through pump 100.

The controller can optimize the linear actuator and pump drive motor to dispense an extremely accurate volume of liquid by collecting data from sensors, analyzing the data, and generating control signals to adjust the operation of the linear actuator or pump drive motor. In some embodiments, a user can, via the controller, manually optimize the rotations and movements of linear actuator and drive pump motor. In other embodiments, the controller does such optimization automatically, in some cases using artificial intelligence or machine learning.

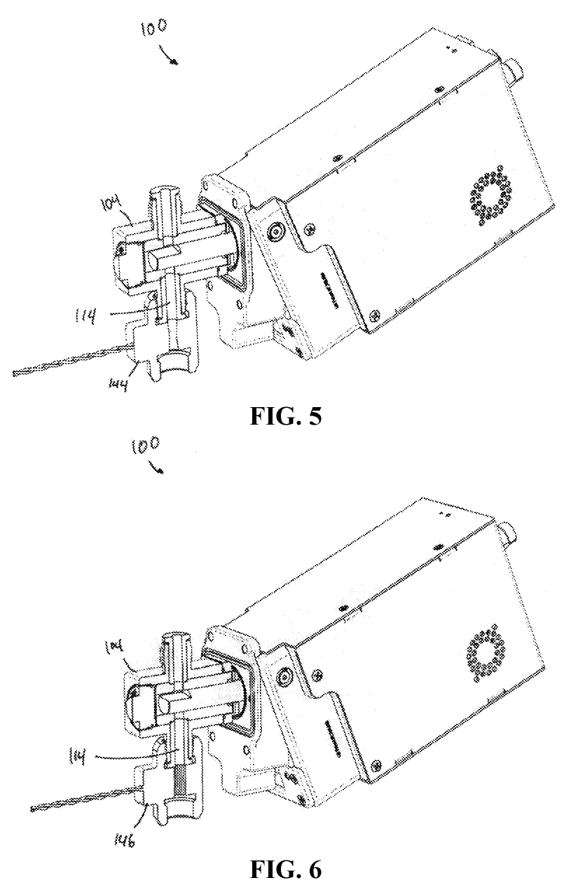

FIG. 5 is a perspective view of a reciprocating pump 100, in accordance with one or more embodiments of the present disclosure. FIG. 5 shows a cross-sectional view of cylinder bore 104 and a cross-sectional view of sensor 144. In some embodiments, sensor 144 is an example of sensor 102 that is configured to measure the rate or volume of liquid that passes through port 114. In some embodiments, sensor 144 is a venturi flowmeter, which can collect flow rate data and determine a flow rate by artificially constricting the flow and measuring a pressure differential. For example, sensor 144 of FIG. 5 may include an upstream pressure sensor and a downstream pressure sensor with a restriction between the two sensors. In this instance, a flow rate can be determined by measuring a pressure differential between the upstream sensor and the downstream sensor. As liquid exits cylinder bore 104, the liquid passes through sensor 144, which measures the flow rate, and determines a volume or mass of liquid that passes through during a set or predetermined period time.

In some embodiments, sensor 144 collects data including flow rate data, pressure, velocity, movement, volume, mass, etc. In some embodiments, sensor 144 transmits control signals including the collected data to the controller for adjustment analysis.

In one or more embodiments, sensor 144 is not integrally formed with cylinder bore 104 or any other part of pump 100. Instead, sensor 144 is removably coupled to port 112 or 114 in any suitable manner. For example, as shown in FIG. 5, sensor 144 is threadedly coupled to port 114.

FIG. 6 is a perspective view of a reciprocating pump 100, in accordance with one or more embodiments of the present disclosure. FIG. 6 also depicts sensor 146 that is removably coupled to port 114. In some embodiments, sensor 146 is a thermal mass flow meter that can determine a flow rate based on differences in temperature in a fluid passing an upstream temperature sensor and a downstream temperature sensor with a heat source between the upstream sensor and downstream sensor. Since the rate at which fluid absorbs heat is proportional to its mass flow rate, sensor 146 can determine a flow rate based on the temperature difference which indicates the heat absorbed by the fluid.

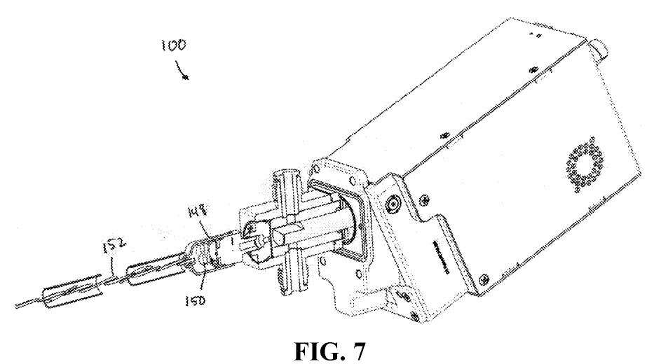

FIG. 7 is a perspective view of a reciprocating pump 100 with a distal end sensor 148, in accordance with one or more embodiments of the present disclosure. FIG. 7 includes a cross-sectional view of cylinder bore 104 and a distal end sensor 148 that is coupled to a distal end of cylinder bore 104. In some embodiments, distal end sensor 148 is removably coupled to the distal end of cylinder bore 104, and in one or more embodiments, distal end sensor 148 is threadedly coupled to the distal end of cylinder bore 104. In other embodiments, distal end sensor 148 is integrally formed with cylinder bore 104. Distal end sensor 148 may be any kind of sensor that can measure and determine a flow rate of liquid passing through cylinder bore 104. For example, in some embodiments, distal end sensor 148 is a pressure sensor (e.g., a pressure transducer) that can measure a characteristic, such as a pressure, of liquid or other fluid passing through cylinder bore 104. In one or more embodiments, cylinder bore 104 includes an opening at the distal end, which allows distal end sensor 148 to use a diaphragm 150 to measure an internal pressure of cylinder bore 104, thus allowing distal end sensor 148 to determine a flow rate of liquid passing through cylinder bore 104. Distal end sensor 148 may then transmit control signals including the measured pressure data to the controller via power cable 152, or in some cases the transmission may be wireless.

While not shown together in any of the figures, a sensor such as distal end sensor 148 may be utilized in conjunction with other sensors, including one or more sensors coupled to ports 112 and 114, in various combinations. For example, in some embodiments, pump 100 includes a distal end sensor 148, a sensor coupled to port 112 and/or a sensor coupled to port 114. In such a configuration, redundant measurements of pressure and flow may help to increase the accuracy of such measurements by taking an average of each of the measurements and using the average as the determined value (e.g., of pressure or flow rate). Additionally, measurements taken by various sensors coupled to ports 112 and 114 and the distal end of cylinder bore 104 may be combined with one or both encoders (i.e., motor drive encoder 122 and linear actuator encoder 142) for additional adjustment analysis for increased accuracy.

Adjustment analysis or calibration of pump 100 may include taking measurements of flow rate, velocity, density, mass, etc. via sensor 102, 144, 146, and/or 148 and comparing the measurements to the intended or desired values. If the measured values do not match the intended or desired values, then control signal may be transmitted to pump 100 with instructions that an adjustment be made to pump 100 to address, compensate, and/or correct for the mismatch/discrepancy/error. Thus, a closed-loop feedback system may provide accurate calibration and compensation for errors. All such calibration and compensation of errors may be completed automatically without manual intervention by receiving input from sensors and encoders, analyzing the input, and sending instructions to pump drive motor 118 and linear actuator 126 for adjustment responsive to the feedback from the sensors and encoders. Calibration curves may be used for the analysis to determine how much correction and compensation is necessary. The calibration curves may be generated using a gravimetric analysis method or in some embodiments, the calibration curves are generated and refined using machine learning as pump 100 functions. Additionally, if errors are detected using the various sensors and encoders, a notification may be generated to alert a user of the errors, especially in the case where the errors are greater than the automatic compensation is capable of correcting.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A fluid dispensing system comprising:
a pump;
a motor coupled to the pump to selectively drive a movable element;
one or more sensors in communication with at least one of (i) the motor and (ii) the pump, and configured to determine position data of the movable element and an output flow rate of the pump; and
a controller in communication with the motor and configured to dynamically adjust the motor relative to an amount of fluid dispensed from the system.

2. The fluid dispensing system of claim 1, further comprising an adjustment mechanism configured to linearly translate the movable element, wherein the controller is configured to dynamically adjust the adjustment mechanism relative to an amount of fluid dispensed from the system.

3. The fluid dispensing system of claim 2, wherein the controller is configured to receive position data and flow rate data to dynamically adjust the motor and/or the adjustment mechanism relative to an amount of fluid dispensed from the system based, at least in part, on the received position data and the flow rate data.

4. The fluid dispensing system of claim 2, wherein the one or more sensors comprise a first position sensor associated with the motor configured to determine a position of the motor and a second position sensor associated with the adjustment mechanism to determine a position of the adjustment mechanism.

5. The fluid dispensing system of claim 4, wherein the pump comprises a piston and a cylinder bore.

6. The fluid dispensing system of claim 5, wherein the adjustment mechanism is configured to adjust a stroke of the piston.

7. The fluid dispensing system of claim 4, wherein the controller is configured to:
receive position data from the first position sensor and the second position sensor;
receive flow rate data from the one or more sensors;
determine discrepancies responsive to the position data and the flow rate data; and
transmit control signals to adjust the motor and/or the adjustment mechanism to correct the determined discrepancies.

8. The fluid dispensing system of claim 1, further comprising a pump drive encoder configured to generate data corresponding to or receive data from the motor.

9. The fluid dispensing system of claim 8, wherein the pump drive encoder is coupled to the motor and configured to receive or monitor motion, position, and/or rotation data of the motor.

10. The fluid dispensing system of claim 9, wherein the pump drive encoder provides the received or monitored motion, position and/or rotation data of the motor to the controller.

11. The fluid dispensing system of claim 5, wherein the motor is configured to selectively drive a reciprocating motion of the piston within the cylinder bore.

12. The fluid dispensing system of claim 5, further comprising a distal sensor coupled to a distal end of the cylinder bore.

13. The fluid dispensing system of claim 12, wherein the distal sensor is configured measure a pressure of a fluid passing through the cylinder bore.

14. The fluid dispensing system of claim 2, wherein the adjustable mechanism comprises a pillow block and a linear actuator comprising a lead screw that is threaded into a center of the pillow block, wherein the linear actuator controls a position of the pillow block.

15. A method of dynamically calibrating a fluid dispensing system, the method comprising:
receiving position data from a position sensor associated with a motor configured to drive a reciprocating pump dispenser;
receiving flow rate data from a sensor associated with the reciprocating fluid pump dispenser;
comparing the received flow rate data with a predefined flow rate data to determine any discrepancies;
determining corrections to be applied to the motor to compensate for the determined differences; and
transmitting control signals including the corrections to the motor.

16. The method of claim 15, further comprising:
receiving position data for an adjustment mechanism;
determining additional corrections to be applied to the adjustment mechanism responsive to the determined discrepancies; and
transmitting control signals including the additional corrections to the adjustment mechanism.

17. The method of claim 15, wherein the determined corrections are configured to cause a flow rate of the fluid pump dispenser to be at least substantially equivalent to a predefined flow rate indicated by the predefined flow rate data.

18. The method of claim 15, wherein the sensor is a pressure transducer configured to measure one or more characteristics of a fluid within the fluid pump dispenser.

19. The method of claim 16, further comprising:
receiving first temperature data from a first temperature sensor in a fluid flow path;
receiving second temperature data from a second temperature sensor positioned downstream in the fluid flow path from the first temperature sensor;
comparing a temperature measured at the first temperature sensor with a temperature measured at the second sensor;
determining a flow rate based on a temperature difference between the temperature measured at the first temperature sensor and the temperature measured at the second sensor; and
transmitting one or more control signals to the motor and/or the adjustment mechanism based, at least in part, on the determined flow rate.

20. A displacement fluid dispensing system, the system comprising:
a displacement mechanism having a movable element within a chamber;
an actuator element coupled to the displacement mechanism to selectively actuate movement of the movable element;
a first position sensor in communication with the motor to monitor a position of the motor;
an adjustment component configured to modify a position of the movable element;
a second position sensor in communication with the adjustment mechanism to monitor a position of the adjustment mechanism;
one or more sensors configured to measure an output flow rate of the positive displacement pump; and
a controller programmed to:
collect position information from the first position sensor and the second positions sensor;
gather flow rate data from the first position sensor and the second positions sensor;
identify mismatches based on the position information and the flow rate data; and
send control signals to the motor and/or the adjustment mechanism to compensate for these mismatches.
